(19) United States
(12) Patent Application Publication
(10) Pub. No.: US 2017/0219803 A1
(43) Pub. Date: Aug. 3, 2017

(54) PHOTOGRAPHIC LENS OPTICAL SYSTEM

(71) Applicant: KOLEN CO., LTD., Gyeonggi-do (KR)

(72) Inventors: Jong Jin Lee, Seoul (KR); Chan Goo Kang, Gyeonggi-do (KR); Seong Hee Bae, Gyeonggi-do (KR)

(21) Appl. No.: 15/417,566

(22) Filed: Jan. 27, 2017

(30) Foreign Application Priority Data
Jan. 28, 2016 (KR) 10-2016-0010711

(51) Int. Cl. G02B 13/00; G02B 5/20; G02B 9/62

(52) U.S. Cl. CPC G02B 13/0045; G02B 9/62; G02B 5/208

(57) ABSTRACT

Provided are photographic lens optical systems. A photographic lens optical system may include a first lens, a second lens, a third lens, a fourth lens, a fifth lens, and a sixth lens that are located between an object and an image sensor on which an image of the object is formed and are sequentially arranged from the object. The first lens may have a positive (+) refractive power. The second lens may have a negative (−) refractive power and may have an exit surface concave from the image sensor. The third lens may have a positive (+) refractive power and may have an exit surface convex toward the image sensor. The fourth lens may have a negative (−) refractive power and may have a meniscus shape convex toward the object. The fifth lens may have a positive (+) refractive power and may have an exit surface convex toward the image sensor. The sixth lens may have a negative (−) refractive power and at least one of an incident surface and an exit surface of the sixth lens may have at least one inflection point from a central portion to an edge. A viewing angle FOV of the lens optical system may satisfy 85°<FOV<95°.

### CROSS-REFERENCE TO RELATED APPLICATION

This application claims the benefit of Korean Patent Application No. 10-2016-0010711, filed on Jan. 28, 2016, in the Korean Intellectual Property Office, the disclosure of which is incorporated herein in its entirety by reference.

### BACKGROUND

1. Field

One or more embodiments relate to an optical device, and more particularly, to a lens optical system used in a camera.

2. Description of the Related Art

Recently, the distribution and utilization of cameras using solid-state imaging devices such as complementary metal oxide semiconductor (CMOS) image sensors or charge-coupled devices (CCDs) have rapidly increased. Camera resolution has been increased by increasing the degree of pixel integration of solid-state imaging devices. Also, size and weight of cameras have been reduced by improving the performance of lens optical systems embedded in the cameras.

A lens optical system of a general small camera (e.g., a camera for a mobile phone) uses many lenses including one or more glass lenses in order to ensure sufficient photographic performance. However, glass lenses have high manufacturing costs and there are limitations in forming/processing the glass lenses, thereby making it difficult to miniaturize a lens optical system. Also, a lens optical system used in an existing camera phone has a viewing angle ranging generally from about 60° to about 65°.

There is a demand for a lens optical system that has a small size, wide viewing angle, and high performance such as satisfactory aberration correction and high resolution and which may solve the problems of glass lenses.

### SUMMARY

One or more embodiments include a lens optical system that has a small (ultra-small) size, wide viewing angle, and high performance.

One or more embodiments include a lens optical system that has a small (ultra-small) size and high brightness.

One or more embodiments include a lens optical system that may be fabricated with reduced manufacturing costs by excluding glass lenses.

Additional aspects will be set forth in part in the description which follows and, in part, will be apparent from the description, or may be learned by practice of the presented embodiments.

According to one or more embodiments, a lens optical system includes a first lens, a second lens, a third lens, a fourth lens, a fifth lens, and a sixth lens that are located between an object and an image sensor on which an image of the object is formed and are sequentially arranged from the object, wherein the first lens has a positive (+) refractive power, the second lens has a negative (−) refractive power and has an exit surface concave from the image sensor, the third lens has a positive (+) refractive power and has an exit surface convex toward the image sensor, the fourth lens has a negative (−) refractive power and has a meniscus shape convex toward the object, the fifth lens has a positive (+) refractive power and has an exit surface convex toward the image sensor, and the sixth lens has a negative (−) refractive power, and at least one of an incident surface and an exit surface of the sixth lens has at least one inflection point from a central portion to an edge.

The lens optical system may satisfy at least one of Condition 1 through Condition 8.

85°<FOV<95° (1),

where FOV is a viewing angle (angle of view) (8) of the lens optical system.

0.85<TTL/ImgH<0.95 (2),

where TTL is a distance between an incident surface of the first lens and the image sensor and ImgH is a diagonal length of an effective pixel area of the image sensor.

0.4<f/ImgH<0.5 (3),

where f is a focal length of the lens optical system and ImgH is a diagonal length of an effective pixel area of the image sensor.

1.6<Fno<1.7 (4),

where Fno is an F-number of the lens optical system.

1.4<D1/D3<1.8 (5),

where D1 is an outer diameter of the first lens and D3 is an outer diameter of the third lens.

0.5<D1/D6<0.7 (6),

where D1 is an outer diameter of the first lens and D6 is an outer diameter of the sixth lens.

10<f2/f6<20 (7),

where f2 is a focal length of the second lens and f6 is a focal length of the sixth lens.

1.5<(Nd1+Nd2)/2<1.7 (8),

where Nd1 is a refractive index of the first lens and Nd2 is a refractive index of the second lens.

At least one of an incident surface and an exit surface of the first lens may have at least one inflection point from a central portion to an edge

An incident surface of the second lens may be convex toward the object.

The third lens may be a biconvex lens, wherein an absolute value of a radius of curvature of an incident surface of the third lens may be greater than an absolute value of a radius of curvature of the exit surface of the third lens.

The first through sixth lenses may be aspheric lenses.

The first through sixth lenses may be plastic lenses.

The lens optical system may further include an aperture located between the second lens and the third lens.

The aperture may be located between the second lens and the third lens.

The lens optical system may further include an infrared ray blocking unit located between the sixth lens and the image sensor.

The infrared ray blocking unit may be located between the sixth lens and the image sensor.

According to one or more embodiments, a lens optical system includes a first lens, a second lens, a third lens, a fourth lens, a fifth lens, and a sixth lens that are located between an object and an image sensor on which an image of the object is formed and are sequentially arranged from the object, wherein the first lens, the second lens, the third lens, the fourth lens, the fifth lens, and the sixth lens respectively have a positive (+) refractive power, a negative (−) refractive power, a positive (+) refractive power, a negative (−) refractive power, a positive (+)refractive power, and a negative (−) refractive power, wherein FOV is a viewing angle of the lens optical system, TTL is a distance between an incident surface of the first lens and the image sensor, and ImgH is a diagonal length of an effective pixel area of the image sensor, wherein FOV, TTL, and ImgH satisfy

85°<FOV<95°, and

0.85<TTL/ImgH<0.95.

When f is a focal length of the lens optical system, ImgH is a diagonal length of an effective pixel area of the image sensor, Fno is an F-number of the lens optical system, D1 is an outer diameter of the first lens, D3 is an outer diameter of the third lens, D6 is an outer diameter of the sixth lens, f2 is a focal length of the second lens, f6 is a focal length of the sixth lens, Nd1 is a refractive index of the first lens, and Nd2 is a refractive index of the second lens, the above f, ImgH, Fno, D1, D3, D6, f2, f6, Nd1, and Nd2 may satisfy at least one of:

0.4<f/ImgH<0.5,

1.6<Fno<1.7,

1.4<D1/D3<1.8,

0.5<D1/D6<0.7,

10<f2/f6<20, and

1.5<(Nd1+Nd2)/2<1.7.

At least one of the incident surface and an exit surface of the first lens may have at least one inflection point from a central portion to an edge.

The second lens may be concave from the image sensor.

The third lens may be convex toward the image sensor.

The fourth lens may be a meniscus lens convex toward the object.

The fifth lens may be a meniscus lens convex toward the image sensor.

The sixth lens may be an aspheric lens. At least one of an incident surface and an exit surface of the sixth lens may have at least one inflection point from a central portion to an edge.

### BRIEF DESCRIPTION OF THE DRAWINGS

These and/or other aspects will become apparent and more readily appreciated from the following description of the embodiments, taken in conjunction with the accompanying drawings in which:

FIGS. 1 through 3 are cross-sectional views illustrating arrangements of main elements of lens optical systems according to first through third embodiments;

FIG. 4 illustrates a longitudinal spherical aberration, an astigmatic field curvature, and a distortion of the lens optical system according to the first embodiment;

FIG. 5 illustrates a longitudinal spherical aberration, an astigmatic field curvature, and a distortion of the lens optical system according to the second embodiment; and

FIG. 6 illustrates a longitudinal spherical aberration, an astigmatic field curvature, and a distortion of the lens optical system according to the third embodiment.

### DETAILED DESCRIPTION

Reference will now be made in detail to embodiments, examples of which are illustrated in the accompanying drawings, wherein like reference numerals refer to like elements throughout. Expressions such as “at least one of,” when preceding a list of elements, modify the entire list of elements and do not modify the individual elements of the list.

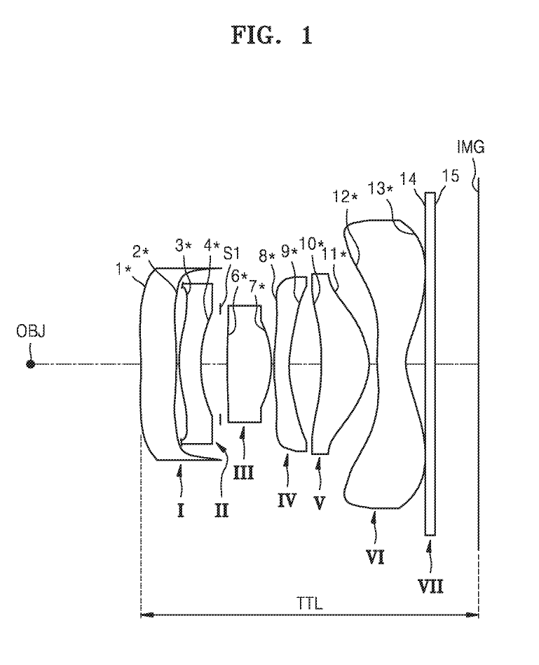

FIGS. 1 through 3 are cross-sectional views illustrating lens optical systems according to first through third embodiments.

Referring to FIGS. 1 through 3, the lens optical system according to each of the first through third embodiments may include a first lens I, a second lens II, a third lens III, a fourth lens IV, a fifth lens V, and a sixth lens VI that are located between an object OBJ and an image sensor IMG on which an image of the object OBJ is formed and are sequentially arranged from the object OBJ. The first lens I may have a positive (+) refractive power. At least one of an incident surface 1* and an exit surface 2* of the first lens I may have at least one inflection point from a central portion to an edge. Each of the incident surface 1* and the exit surface 2* of the first lens I may be convex toward the image sensor IMG at the central portion and may be concave to the edge. The second lens II may have a negative (−) refractive power and may be concave from the image sensor IMG. An exit surface 4* of the second lens II may be concave from the image sensor IMG. An incident surface 3* of the second lens II may be convex toward the object OBJ. Accordingly, the second lens II may be a meniscus lens convex toward the object OBJ.

The third lens III may have a positive (+) refractive power and may be convex toward the image sensor IMG. An exit surface 7* of the third lens III may be convex toward the image sensor IMG and an incident surface 6* of the third lens III may be convex toward the object OBJ. Accordingly, the third lens III may be a biconvex lens whose both surfaces (i.e., the incident surface 6* and the exit surface 7*) are convex. In this case, an absolute value of a radius of curvature of the incident surface 6* may be greater than an absolute value of a radius of curvature of the exit surface 7*. The fourth lens IV may have a negative (−) refractive power and may be a meniscus lens convex toward the object OBJ. An incident surface 8* and an exit surface 9* of the fourth lens IV may be convex toward the object OBJ. The fifth lens V may have a positive (+) refractive power and may be a meniscus lens convex toward the image sensor IMG. An incident surface 10* and an exit surface 11* of the fifth lens V may be convex toward the image sensor IMG. An absolute value of a radius of curvature of the exit surface 11* of the fifth lens V may be less than an absolute value of a radius of curvature of the incident surface 10* of the fifth lens V.

At least one of the first through fifth lenses I through V may be an aspheric lens. In other words, at least one of the incident surfaces 1*, 3*, 6*, 8*, and 10* and the exit surfaces 2*, 4*, 7*, 9*, and 11* of the first through fifth lenses I through V may be an aspheric surface. For example, all of the incident surfaces 1*, 3*, 6*, 8*, and 10* and the exit surfaces 2*, 4*, 7*, 9*, and 11* of the first through fifth lenses I through V may be aspheric surfaces.

The sixth lens VI may have a negative (−) refractive power and at least one of an incident surface 12* and an exit surface 13* of the sixth lens VI may be an aspheric surface. For example, at least one of the incident surface 12* and the exit surface 13* of the sixth lens VI may be an aspheric surface having at least one inflection point from a central portion to an edge. The incident surface 12* of the sixth lens VI may have one or two inflection points from the central portion to the edge. The incident surface 12* of the sixth lens may be convex toward the object OBJ at the central portion and may be concave to the edge. Alternatively, the incident surface 12* of the sixth lens VI may be convex at the central portion, may be concave to the edge, and may be convex again. The exit surface 13* of the sixth lens VI may have one inflection point from the central portion to the edge. The exit surface 13* of the sixth lens VI may be concave from the image sensor IMG at the central portion and may be convex to the edge.

An aperture S1 and an infrared ray blocking unit VII may be further located between the object OBJ and the image sensor IMG. The aperture S1 may be located between the second lens II and the third lens III. The infrared ray blocking unit VII may be located between the sixth lens VI and the image sensor IMG. The infrared ray blocking unit VII may be an infrared ray blocking filter. Positions of the aperture S1 and the infrared ray blocking unit VII may be changed. The first and second lenses I and II located in front of the aperture S1 may be included in a first lens group in consideration of the position of the aperture S1, and the third through sixth lenses III through VI located behind the aperture S1 may be included in a second lens group.

Regarding the lens optical system according to embodiments, at least one of Condition 1 through Condition 8 may be satisfied.

85°<FOV<95° (1),

where FOV is a viewing angle (angle of view) θ of the lens optical system. The viewing angle may be a diagonal field of view of the lens optical system.

When the lens optical system satisfies Condition 1, the lens optical system may be small (ultra-small) and have a relatively large viewing angle. A lens optical system used in a general camera phone has a viewing angle ranging from about 60° to about 65°. It is not easy to manufacture an optical system having a small size and a large viewing angle equal to or greater than 85°. However, according to an embodiment, the lens optical system may be small (ultra-small) and may have a large viewing angle equal to or greater than 85° through design optimization.

0.85<TTL/ImgH<0.95 (2),

where TTL is a distance between the incident surface 1* of the first lens I and the image sensor IMG, that is, a total length of the lens optical system. TTL is a length measured along an optical axis. In other words, TTL refers to a linear distance from the central portion of the incident surface 1* of the first lens Ito the image sensor IMG along the optical axis. ImgH is a diagonal length of an effective pixel area of the image sensor IMG.

Condition 2 defines a ratio of the total length TTL of the lens optical system to an image size (i.e., ImgH). According to Condition 2, the lens optical system is more compact as a value TTL/ImgH is closer to a lower limit of 0.85. However, when the value TTL/ImgH is less than the lower limit of 0.85, various aberrations such as a spherical aberration may increase. Although an aberration may be more easily corrected as the value TTL/ImgH is closer to an upper limit of 0.95, if the value TTL/ImgH is greater than the upper limit of 0.95, the total length of the lens optical system may increase, thereby making it difficult to make the lens optical system compact. Hence, when the value TTL/ImgH ranges from 0.85 to 0.95, the lens optical system may be compact and may ensure high performance.

0.4<f/ImgH<0.5 (3),

where f is a focal length of the lens optical system and ImgH is a diagonal length of an effective pixel area of the image sensor IMG.

Condition 3 defines a ratio of the focal length f of the lens optical system to an image size (i.e., ImgH). According to Condition 3, when a value f/ImgH is close to or less than a lower limit of 0.4, the lens optical system may have a short focal length but it may be difficult to control an aberration. When the value f/ImgH is close to or greater than an upper limit of 0.5, it may be easy to control an aberration but it may be difficult to optimize a focal length.

1.6<Fno<1.7 (4),

where Fno is an F-number of the lens optical system.

Condition 4 is related to a brightness of the lens optical system. Fno is a ratio between an effective aperture (diameter) and a focal length of the lens optical system. A brightness of the lens optical system may increase as the ratio Fno decreases. A general 6-lens optical system has Fno greater than about 2.0. However, according to an embodiment, the lens optical system may be a 6-lens optical system having Fno equal to or less than 1.7 through design optimization. In other words, the lens optical system may have a high brightness, which is difficult to achieve by using an existing 6-lens optical system. Accordingly, the lens optical system may easily obtain a brighter image.

1.4<D1/D3<1.8 (5),

where D1 is an outer diameter of the first lens I and D3 is an outer diameter of the third lens III.

Condition 5 defines a ratio between the outer diameter of the first lens I and the outer ratio of the third lens III. An optical system used in a general camera phone (e.g., a mobile phone) is formed so that an outer diameter of a first lens close to an object is the smallest and outer diameters of lenses sequentially increase toward an image sensor. However, in an embodiment, the outer diameter of the third lens III may be the smallest. Accordingly, an aberration may be easily controlled and a wide angle may be achieved.

0.5<D1/D6<0.7 (6),

where D1 is an outer diameter of the first lens I and D6 is an outer diameter of the sixth lens VI.

Condition 6 defines a ratio between the outer diameter of the first lens I and the outer diameter of the sixth lens VI. That is, Condition 6 defines a size ratio between the first and sixth lenses I and VI that are located at both ends. An optical system used in a general camera phone (e.g., a mobile phone) may be formed so that a size ratio between a first lens close to an object and a last lens close to an image sensor is equal to or less than about 0.5. However, in an embodiment, a ratio D1/D6 may be greater than 0.5 and less than 0.7 through new design optimization of the lens optical system.

10<f2/f6<20 (7),

where f2 is a focal length of the second lens II and f6 is a focal length of the sixth lens VI.

Condition 7 defines a ratio between the focal length of the second lens II and the focal length of the sixth lens VI. Condition 7 is a condition for appropriately controlling a refractive power arrangement of the lens optical system. When Condition 7 is satisfied, a refractive power arrangement/distribution may be appropriately controlled and the lens optical system may have a small size, a wide angle, and high performance.

1.5<(Nd1+Nd2)/2<1.7 (8),

where Nd1 is a refractive index of the first lens I and Nd2 is a refractive index of the second lens II.

Condition 8 is a condition about materials of the first lens I and the second lens II. When Condition 8 is satisfied, it may mean that inexpensive plastic lenses may be used as the first and second lenses I and II. Accordingly, according to an embodiment, predetermined costs may be reduced. Also, when Condition 8 is satisfied, problems such as coma aberration and astigmatism may be appropriately controlled by controlling refractive indices of the first and second lenses I and II.

In the above first through third embodiments, values of Condition 1 through Condition 8 are shown in Table 1. In Table 1, a unit of a viewing angle FOV is °. Table 2 shows variables needed to obtain Table 1. In Table 2, units of values TTL, ImgH, f, f2, f6, D1, D3, and D6 are mm.

TABLE 1

| | | First | Second | Third |
|---|---|---|---|---|
| Condition | Formula | embodiment | embodiment | embodiment |
| 1 | FOV | 89.900 | 89.991 | 89.900 |
| 2 | TTL/ImgH | 0.906483 | 0.895622 | 0.895622 |
| 3 | f/ImgH | 0.4993 | 0.4953 | 0.4959 |
| 4 | Fno | 1.680 | 1.680 | 1.680 |
| 5 | D1/D3 | 1.651678 | 1.650159 | 1.648876 |
| 6 | D1/D6 | 0.637556 | 0.63976 | 0.642969 |
| 7 | f2/f6 | 16.35438 | 13.96729 | 13.38085 |
| 8 | (Nd1 + Nd2)/2 | 1.594413 | 1.594413 | 1.594413 |

TABLE 2

| | First embodiment | Second embodiment | Third embodiment |
|---|---|---|---|
| TTL | 3.887 | 3.887 | 3.887 |
| ImgH | 4.288 | 4.340 | 4.340 |
| f | 2.141 | 2.150 | 2.152 |
| D1 | 2.333 | 2.333 | 2.333 |
| D3 | 1.412 | 1.414 | 1.415 |
| D6 | 3.659 | 3.646 | 3.628 |
| f2 | −24.251 | −20.700 | −19.959 |
| f6 | −1.483 | −1.482 | −1.492 |
| Nd1 | 1.547 | 1.547 | 1.547 |
| Nd2 | 1.642 | 1.642 | 1.642 |

Referring to Table 1 and Table 2, the lens optical system in each of the first through third embodiments satisfies Condition 1 through Condition 8.

In the lens optical system according to the above embodiments, the first through sixth lenses I through VI may be made of plastic in consideration of shapes and dimensions. That is, all of the first through sixth lenses I through VI may be plastic lenses. Glass lenses have high manufacturing costs and there are limitations in forming/processing the glass lenses, thereby making it difficult to miniaturize a lens optical system. However, since all of the first through sixth lenses I through VI may be made of plastic in the present embodiment, various advantages may be obtained. However, embodiments are not limited to the feature that the first through sixth lenses I through VI are made of plastic. If necessary, at least one of the first through sixth lenses I through VI may be made of glass.

The first through third embodiments will now be explained in more detail with reference to lens data and the attached drawings.

Each of Table 3 through Table 5 shows a radius of curvature of each lens, a lens thickness or a distance between lenses, a refractive index, and an Abbe number in the lens optical system in each of FIGS. 1 through 3. In Table 3 through Table 5, R is a radius of curvature, D is a lens thickness, a lens interval, or an interval between adjacent elements, Nd is a refractive index of a lens measured by using a d-line, and Vd is an Abbe number of a lens with respect to a d-line. * beside a lens surface number indicates that a lens surface is aspheric. Units of values R and D are mm.

TABLE 3

| First | | | | | |
|---|---|---|---|---|---|
| embodiment | Surface | R | D | Nd | Vd |
| I | 1* | −6.8392 | 0.4206 | 1.547 | 56.071 |
| | 2* | −4.2275 | 0.0250 | | |
| II | 3* | 1.2520 | 0.2602 | 1.642 | 23.901 |
| | 4* | 1.0646 | 0.2310 | | |
| | S1 | Infinity | 0.0800 | | |
| III | 6* | 4.7608 | 0.5331 | 1.547 | 56.071 |
| | 7* | −1.2325 | 0.0250 | | |
| IV | 8* | 2.4769 | 0.1850 | 1.658 | 21.521 |
| | 9* | 1.3871 | 0.3869 | | |
| V | 10* | −2.6163 | 0.5636 | 1.547 | 56.071 |
| | 11* | −0.7064 | 0.1000 | | |
| VI | 12* | 3.1318 | 0.3400 | 1.547 | 56.071 |
| | 13* | 0.6196 | 0.2365 | | |
| VII | 14 | Infinity | 0.1100 | | |
| | 15 | Infinity | 0.3860 | | |
| | IMG | Infinity | 0.0040 | | |

TABLE 4

| Second | | | | | |
|---|---|---|---|---|---|
| embodiment | Surface | R | D | Nd | Vd |
| I | 1* | −6.7181 | 0.4219 | 1.547 | 56.071 |
| | 2* | −3.9692 | 0.0250 | | |
| II | 3* | 1.2572 | 0.2618 | 1.642 | 23.901 |
| | 4* | 1.0550 | 0.2346 | | |
| | S1 | Infinity | 0.0800 | | |
| III | 6* | 4.7745 | 0.5333 | 1.547 | 56.071 |
| | 7* | −1.2265 | 0.0250 | | |
| IV | 8* | 2.3503 | 0.1850 | 1.658 | 21.521 |
| | 9* | 1.3441 | 0.3944 | | |
| V | 10* | −2.5999 | 0.5583 | 1.547 | 56.071 |
| | 11* | −0.7101 | 0.1000 | | |
| VI | 12* | 3.2761 | 0.3400 | 1.547 | 56.071 |
| | 13* | 0.6261 | 0.2278 | | |
| VII | 14 | Infinity | 0.1100 | | |
| | 15 | Infinity | 0.3866 | | |
| | IMG | Infinity | 0.0034 | | |

TABLE 5

| Third | | | | | |
|---|---|---|---|---|---|
| embodiment | Surface | R | D | Nd | Vd |
| I | 1* | −6.7631 | 0.4267 | 1.547 | 56.071 |
| | 2* | −3.8783 | 0.0250 | | |
| II | 3* | 1.2234 | 0.2499 | 1.642 | 23.901 |
| | 4* | 1.0276 | 0.2424 | | |
| | S1 | Infinity | 0.0800 | | |
| III | 6* | 4.8209 | 0.5345 | 1.547 | 56.071 |
| | 7* | −1.2246 | 0.0250 | | |
| IV | 8* | 2.3102 | 0.1850 | 1.658 | 21.521 |
| | 9* | 1.3291 | 0.3979 | | |
| V | 10* | −2.5800 | 0.5550 | 1.547 | 56.071 |
| | 11* | −0.7142 | 0.1000 | | |
| VI | 12* | 3.3033 | 0.3400 | 1.547 | 56.071 |
| | 13* | 0.6306 | 0.2256 | | |
| VII | 14 | Infinity | 0.1100 | | |
| | 15 | Infinity | 0.3857 | | |
| | IMG | Infinity | 0.0043 | | |

An F-number Fno, a focal length f, and a viewing angle FOV of the lens optical system in each of the first through third embodiments respectively corresponding to FIGS. 1 through 3 are shown in Table 6.

TABLE 6

| | F- | | Viewing |
|---|---|---|---|
| Embodiment | number Fno | Focal length f [mm] | angle FOV [°] |
| First embodiment | 1.680 | 2.1410 | 89.900 |
| Second embodiment | 1.680 | 2.1496 | 89.991 |
| Third embodiment | 1.680 | 2.1521 | 89.900 |

Also, an aspheric surface of each lens in the lens optical system according to each of the first through third embodiments satisfies the following aspheric equation.

<Aspheric Equation>

$$x = \frac{{c}^{′} {y}^{2}}{1 + \sqrt{1 - ( K + 1 ) {{c}^{′}}^{2} {y}^{2}}} + {Ay}^{4} + {By}^{6} + {Cy}^{8} + {Dy}^{10} + {Ey}^{12}$$

where x is a distance from a vertex of a lens in a direction parallel to an optical axis, y is a distance in a direction perpendicular to the optical axis, c′ is a reciprocal of a radius of curvature at the vertex of the lens, K is a conic constant, and A, B, C, D, and E are aspheric coefficients.

Each of Table 7 through Table 9 shows aspheric coefficients of aspheric surfaces in the lens system according to each of the first through third embodiments respectively corresponding to FIGS. 1 through 3. That is, Table 7 through T9 show aspheric coefficients of the incident surfaces 1*, 3*, 6*, 8*, 10*, and 12* and the exit surfaces 2*, 4*, 7*, 9*, 11*, and 13* of the lenses of Table 3 through Table 5.

TABLE 7

| Sur- | | | | | | |
|---|---|---|---|---|---|---|
| face | K | A | B | C | D | E |
| 1* | −120.9741 | 0.2087 | −0.2970 | 0.6270 | −0.9157 | 0.8562 |
| 2* | −76.1813 | −0.0189 | 1.2390 | −5.0116 | 11.8918 | −17.7292 |
| 3* | −8.2747 | −0.1492 | 0.2516 | −0.4077 | −8.5709 | 33.4116 |
| 4* | −2.0021 | −0.6050 | 2.2462 | −17.8775 | 114.7893 | −491.6660 |
| 6* | 38.4044 | −0.0655 | −0.7642 | 4.1310 | −22.1120 | 69.4832 |
| 7* | −13.7023 | −1.0693 | 4.3824 | −15.5304 | 12.1143 | 143.9027 |
| 8* | −7.1391 | −0.5519 | 2.2200 | −9.4216 | 26.4775 | −46.6967 |
| 9* | −2.5867 | −0.4500 | 1.3907 | −3.8527 | 7.8865 | −10.6657 |
| 10* | 1.4337 | −0.0130 | 0.0097 | −1.7507 | 6.5061 | −11.2765 |
| 11* | −1.8288 | 0.2325 | −1.0989 | 2.8404 | −5.4725 | 7.4420 |
| 12* | −349.6801 | −0.4130 | 0.2461 | 0.0793 | −0.2424 | 0.1710 |
| 13* | −5.4440 | −0.2738 | 0.3056 | −0.2719 | 0.1722 | −0.0755 |

TABLE 8

| Sur- | | | | | | |
|---|---|---|---|---|---|---|
| face | K | A | B | C | D | E |
| 1* | −120.9741 | 0.2089 | −0.2944 | 0.6184 | −0.8912 | 0.8130 |
| 2* | −76.1813 | −0.0153 | 1.1859 | −4.7251 | 11.0229 | −16.1411 |
| 3* | −8.2093 | −0.1483 | 0.2415 | −0.3988 | −8.4161 | 38.5270 |
| 4* | −2.0246 | −0.6140 | 2.2230 | −16.4048 | 99.5353 | −413.3332 |
| 6* | 38.6066 | −0.0640 | −0.7792 | 4.4293 | −24.1691 | 77.2915 |
| 7* | −13.7853 | −1.0641 | 4.2886 | −14.8075 | 9.5870 | 147.1984 |
| 8* | −6.7283 | −0.5454 | 2.1532 | −9.0145 | 25.1459 | −44.0541 |
| 9* | −2.5594 | −0.4551 | 1.4099 | −3.8772 | 7.8406 | −10.3698 |
| 10* | 1.3138 | −0.0077 | 0.2242 | −1.7584 | 6.5424 | −11.2944 |
| 11* | −1.8301 | 0.2368 | −1.1433 | 3.0278 | −5.9052 | 8.0656 |
| 12* | −349.6801 | −0.4349 | 0.2634 | 0.0921 | −0.2810 | 0.2035 |
| 13* | −5.4282 | −0.2912 | 0.3377 | −0.3126 | 0.2050 | −0.0923 |

TABLE 9

| Sur- | | | | | | |
|---|---|---|---|---|---|---|
| face | K | A | B | C | D | E |
| 1* | −120.9741 | 0.2074 | −0.2867 | 0.5810 | −0.8081 | 0.7134 |
| 2* | −76.1813 | −0.0074 | 1.1573 | −4.7034 | 11.2478 | −16.9613 |
| 3* | −7.8538 | −0.1429 | 0.1859 | −0.3301 | −7.7045 | 34.5612 |
| 4* | −2.1040 | −0.6235 | 2.0826 | −13.7295 | 78.4730 | −320.6095 |
| 6* | 38.8514 | −0.0606 | −0.8328 | 5.5220 | −32.6750 | 113.7246 |
| 7* | −14.1088 | −1.0449 | 4.0817 | −13.6707 | 7.7142 | 139.4243 |
| 8* | −6.3332 | −0.5085 | 1.9263 | −7.9902 | 22.2046 | −38.8111 |
| 9* | −2.5042 | −0.4445 | 1.3897 | −3.8878 | 8.0264 | −10.9261 |
| 10* | 1.1160 | −0.0026 | 0.2188 | −1.7074 | 6.2428 | −10.5701 |
| 11* | −1.8450 | 0.2351 | −1.1476 | 3.1930 | −6.5431 | 9.1813 |
| 12* | −349.6801 | −0.4511 | 0.3777 | −0.1895 | 0.0550 | −0.0074 |
| 13* | −5.5140 | −0.2889 | 0.3423 | −0.3237 | 0.2130 | −0.0949 |

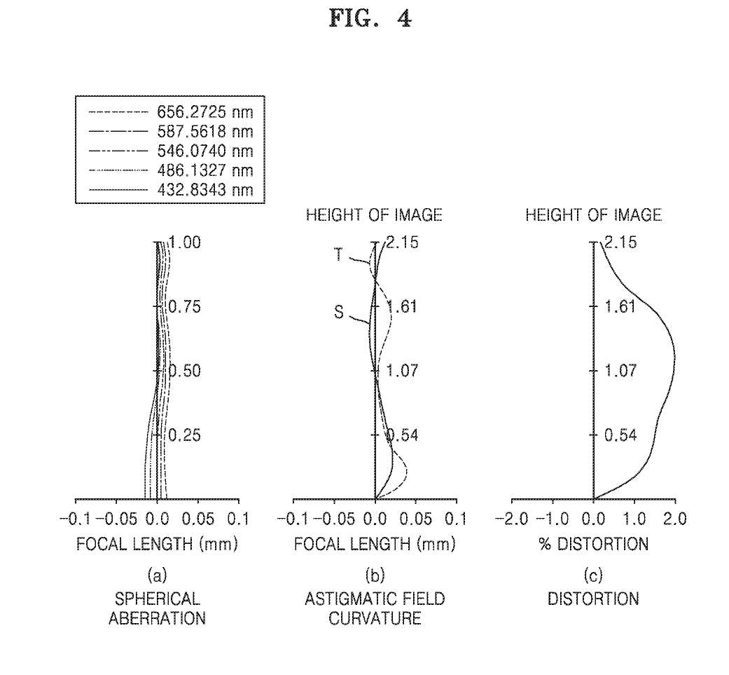

FIG. 4 illustrates a longitudinal spherical aberration, an astigmatic field curvature, and a distortion of the lens optical system according to the first embodiment (FIG. 1), that is, the lens optical system having values of Table 3.

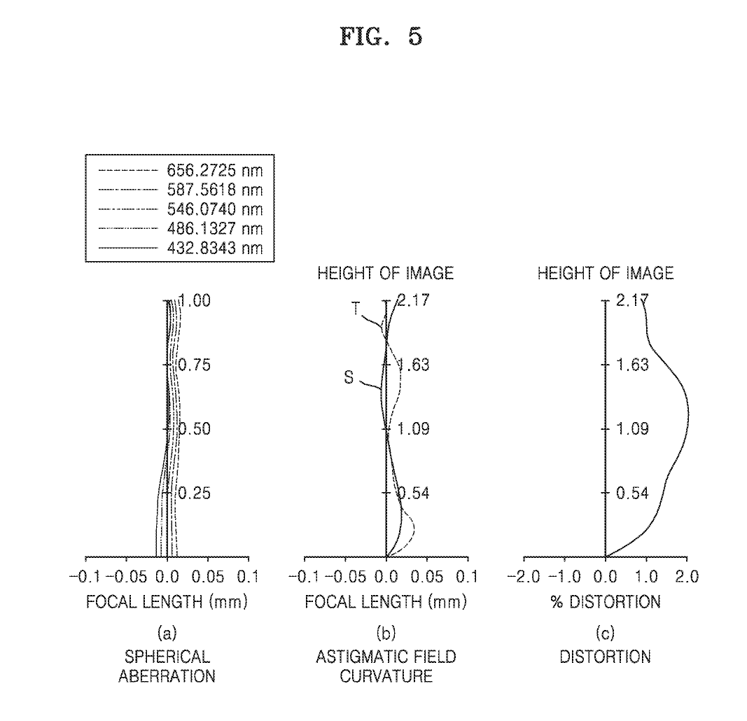

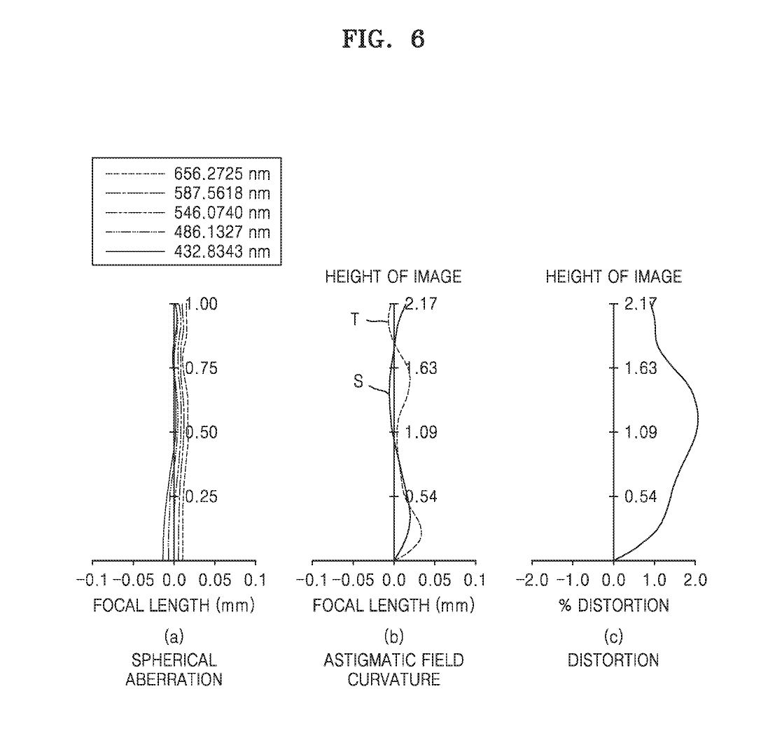

In FIG. 4, (a) shows a spherical aberration of the lens optical system with respect to light having various wavelengths, (b) shows an astigmatic field curvature of the lens optical system, that is, a tangential field curvature T and a sagittal field curvature S. Wavelengths of light used to obtain data of (a) were 656.2725 nm, 587.5618 nm, 546.0740 nm, 486.1327 nm, and 435.8343 nm. Wavelengths of light used to obtain data in (b) and (c) were 546.0740 nm. The same wavelengths are used to obtain data in FIGS. 5 and 6.

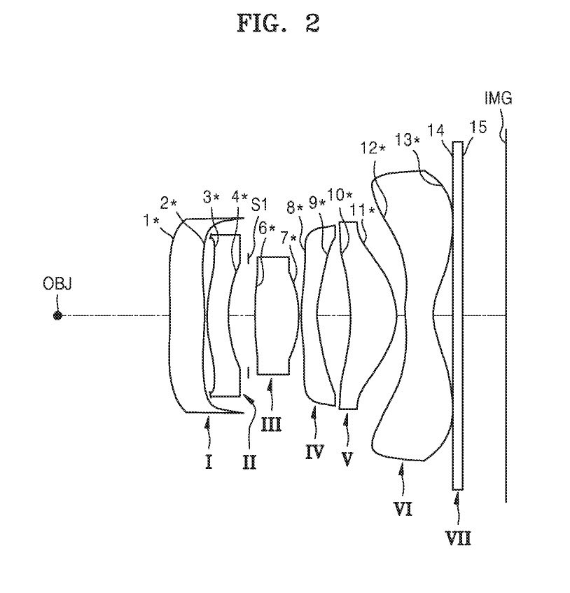

In FIG. 5, (a), (b), and (c) respectively show a longitudinal spherical aberration, an astigmatic field curvature, and a distortion of the lens optical system according to the second embodiment (FIG. 2), that is, the lens optical system having values of Table 4.

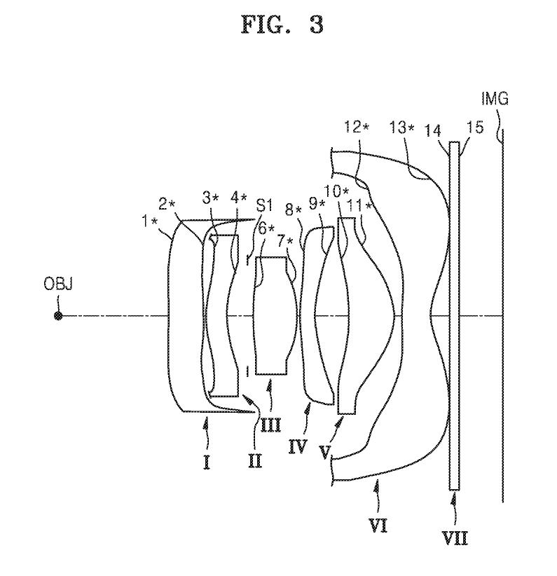

In FIG. 6, (a), (b), and (c) respectively show a longitudinal spherical aberration, an astigmatic field curvature, and a distortion of the lens optical system according to the third embodiment (FIG. 3), that is, the lens optical system having values of Table 5.

As described above, the lens optical system according to embodiments may include the first through sixth lenses I through VI having positive (+), negative (−), positive (+), negative (−), positive (+), and negative (−) refractive power and sequentially arranged from the object OBJ to the image sensor IMG, and may satisfy at least one of Condition 1 through Condition 8. The lens optical system may have a wide viewing angle (wide angle) and a relatively short total length, and may easily correct various aberrations. Accordingly, according to an embodiment, the lens optical system may have a small (ultra-small) size, a wide viewing angle, high performance, and a high resolution.

In particular, when at least one of the incident surface 12* and the exit surface 13* of the sixth lens VI in the lens optical system according to an embodiment is an aspheric surface having at least one inflection point from a central portion to an edge, various aberrations may be easily corrected by using the sixth lens VI having the aspheric surface and an exit angle of a chief ray may be reduced to prevent vignetting.

Also, since the first through sixth lenses I through VI are made of plastic and both surfaces (i.e., an incident surface and an exit surface) of each of the first through sixth lenses I through VI are aspheric surfaces, the lens optical system having a compact size and high performance may be formed with less costs than that of using glass lenses.

While the inventive concept has been particularly shown and described with reference to embodiments thereof, the embodiments have merely been used to explain the inventive concept and should not be construed as limiting the scope of the inventive concept as defined by the claims. For example, it will be understood by one of ordinary skill in the art that a blocking film, instead of a filter, may be used as the infrared ray blocking unit VII. Various other modifications may be made. Accordingly, the scope of the inventive concept is defined not by the detailed description of the inventive concept but by the appended claims.

What is claimed is:

1. A lens optical system comprising a first lens, a second lens, a third lens, a fourth lens, a fifth lens, and a sixth lens that are located between an object and an image sensor on which an image of the object is formed and are sequentially arranged from the object,
wherein the first lens has a positive (+) refractive power,
the second lens has a negative (−) refractive power and has an exit surface concave from the image sensor,
the third lens has a positive (+) refractive power and has an exit surface convex toward the image sensor,
the fourth lens has a negative (−) refractive power and has a meniscus shape convex toward the object,
the fifth lens has a positive (+) refractive power and has an exit surface convex toward the image sensor, and
the sixth lens has a negative (−) refractive power, and at least one of an incident surface and an exit surface of the sixth lens has at least one inflection point from a central portion to an edge.

2. The lens optical system of claim 1, wherein a viewing angle FOV of the lens optical system satisfies
85°<FOV<95°.

3. The lens optical system of claim 1, satisfying
0.85<TTL/ImgH<0.95,
where TTL is a distance between an incident surface of the first lens and the image sensor and ImgH is a diagonal length of an effective pixel area of the image sensor.

4. The lens optical system of claim 1, satisfying
0.4<f/ImgH<0.5,
where f is a focal length of the lens optical system and ImgH is a diagonal length of an effective pixel area of the image sensor.

5. The lens optical system of claim 1, satisfying
1.6<Fno<1.7,
where Fno is an F-number of the lens optical system.

6. The lens optical system of claim 1, satisfying
1.4<D1/D3<1.8,
where D1 is an outer diameter of the first lens and D3 is an outer diameter of the third lens.

7. The lens optical system of claim 1, satisfying
0.5<D1/D6<0.7,
where D1 is an outer diameter of the first lens and D6 is an outer diameter of the sixth lens.

8. The lens optical system of claim 1, satisfying
10<f2/f6<20,
where f2 is a focal length of the second lens and f6 is a focal length of the sixth lens.

9. The lens optical system of claim 1, satisfying
1.5<(Nd1+Nd2)/2<1.7,
where Nd1 is a refractive index of the first lens and Nd2 is a refractive index of the second lens.

10. The lens optical system of claim 1, wherein at least one of an incident surface and an exit surface of the first lens has at least one inflection point from a central portion to an edge.

11. The lens optical system of claim 1, wherein an incident surface of the second lens is convex toward the object.

12. The lens optical system of claim 1, wherein the third lens is a biconvex lens, wherein an absolute value of a radius of curvature of an incident surface of the third lens is greater than an absolute value of a radius of curvature of the exit surface of the third lens.

13. The lens optical system of claim 1, wherein the first through sixth lenses are aspheric lenses.

14. The lens optical system of claim 1, wherein the first through sixth lenses are plastic lenses.

15. The lens optical system of claim 1, further comprising an aperture located between the second lens and the third lens.

16. The lens optical system of claim 1, further comprising an infrared ray blocking unit located between the sixth lens and the image sensor.

17. A lens optical system comprising a first lens, a second lens, a third lens, a fourth lens, a fifth lens, and a sixth lens that are located between an object and an image sensor on which an image of the object is formed and are sequentially arranged from the object,
wherein the first lens, the second lens, the third lens, the fourth lens, the fifth lens, and the sixth lens respectively have a positive (+) refractive power, a negative (−) refractive power, a positive (+) refractive power, a negative (−) refractive power, a positive (+) refractive power, and a negative (−) refractive power,
wherein FOV is a viewing angle of the lens optical system, TTL is a distance between an incident surface of the first lens and the image sensor, and ImgH is a diagonal length of an effective pixel area of the image sensor,
wherein FOV, TTL, and ImgH satisfy
85°<FOV<95°, and
0.85<TTL/ImgH<0.95.

18. The lens optical system of claim 17, wherein f is a focal length of the lens optical system, Fno is an F-number of the lens optical system, D1 is an outer diameter of the first lens, D3 is an outer diameter of the third lens, D6 is an outer diameter of the sixth lens, f2 is a focal length of the second lens, f6 is a focal length of the sixth lens, Nd1 is a refractive index of the first lens, and Nd2 is a refractive index of the second lens,
wherein f, ImgH, Fno, D1, D3, D6, f2, f6, Nd1, and Nd2 satisfy at least one of:
0.4<f/ImgH<0.5,
1.6<Fno<1.7,
1.4<D1/D3<1.8,
0.5<D1/D6<0.7,
10<f2/f6<20, and
1.5<(Nd1+Nd2)/2<1.7.

19. The lens optical system of claim 17, wherein
at least one of the incident surface and an exit surface of the first lens has at least one inflection point from a central portion to an edge,
the second lens is concave from the image sensor,
the third lens is convex toward the image sensor,
the fourth lens is a meniscus lens convex toward the object,
the fifth lens is a meniscus lens convex toward the image sensor, and
the sixth lens is an aspheric lens.
